(19) United States
(12) Patent Application Publication
(10) Pub. No.: US 2010/0332711 A1
(43) Pub. Date: Dec. 30, 2010

(54) Display device with built in hard drive docking station

(76) Inventors: Kin Ip Ll, Hong Kong (HK); Ho Wai Phyllis Leung, Hong Kong (HK); Chun-Kong Joseph Chan, Kwal Chung (HK); Kin Wah Kong, Kwal Chung (HK)

Correspondence Address: Adams and Reese LLP, 1221 McKinney Street, Suite 4400, Houston, TX, 77010, US

(21) Appl. No.: 12/459,331

(22) Filed: Jun. 30, 2009

(51) Int. Cl. G06F 13/00

(52) U.S. Cl. 710/303

(57) ABSTRACT

The invention is directed to a display device having an integral hard disk drive; in particular, a removable integral hard disk drive removable by a docking port. The display device and hard disk drive share a power supply and a housing.

### FIELD OF THE INVENTION

The invention is directed to a display device having auxiliary capabilities.

### BACKGROUND OF THE INVENTION

A typical personal computer system or workstation includes both a display device and storage.

A computer typically requires a display device, such as an LCD monitor, LCD TV display, plasma TV display, CRT monitor or a TV display. The display device is used to display image and video data generated by the computer to a user.

Storage is typically located within the computer itself and typically includes magnetic storage. Magnetic storage devices, such as a hard disk drive, are used to store information in a random access re-writable fashion to allow the computer to execute programs and store data.

In computer systems where additional storage is required or desired, a computer may be provided with auxiliary storage, which may be housed outside the computer in a casing, separately powered from the computer, and connected to the computer by a bus, such as a USB bus interface or other known buses.

In large institutions, having many hundreds or thousands of desktops, the complexity of installing external disk drives and the cost of such external disk drives has prevented their widespread use for data storage. The external disk drives are typically much more expensive than hard disk drives designed for internal use. In most circumstances, the cost per gigabyte of storage using external drives is prohibitively high. The cost of such external disk drives is increased primarily by the cost of a separate power supply which is necessary to power the hard disk drive independently from the computer.

The external hard disk drive also requires additional installation steps in such large institutions. At least two more cables are required: a cable for the bus to communicate with the computer and a cable for power.

There is a need for an apparatus which combines the benefits of hard disk drive storage with an accessible interface and shared power supply, so that such storage may be inexpensive to replace, and may be installed and replaced easily by computer system administrators if necessary.

Using multiple separate drives with the apparatus would enable users to significantly expand the storage capacity of their system without lengthy installations.

Such an apparatus would be particularly useful for data back-ups, as users could back-up data on a multiplicity of separate drives. Accessing specific data through drives in this way would be more efficient than accessing the same data by restoring an entire system. Backing-up on multiple drives would also reduce the overall risk of data loss caused by hard drive failure.

Using interchangeable drives would also increase the flexibility of the backup capabilities of an institution, as the back-up media could be easily accessed and used by multiple systems.

### SUMMARY OF THE INVENTION

The invention is directed to a display device for displaying information and data provided to it by a computer, comprising:
a housing, the display device mounted within the housing to display image data to a user;
a hard disk drive capable of containing stored data located within the housing;
at least one data cable for communicating image data and stored data with the computer;
a power supply located in the housing for powering the display device and hard disk drive; and
a power cable for receiving electrical power from a power source and delivering it to the power supply.

In a principal embodiment, the display device further comprises a docking station capable of accommodating the hard disk drive.

### BRIEF DESCRIPTION OF THE DRAWINGS

Embodiments of the invention will be described by way of example and with reference to the drawings in which:

FIG. 1 is a functional block diagram of the power subsystem in one embodiment of the current invention.

FIG. 2 functional block diagram of the data subsystem in one embodiment of the current invention.

FIG. 3 is a functional block diagram of the power and data subsystem in an alternative embodiment of the current invention.

FIG. 4 is a front view of the device, with a cut-out section showing the hard disk drive docking station.

FIG. 5 is a cross sectional view of the device, showing the manner in which the components are housed together.

FIG. 6 is a detailed view of the docking station, showing how the hard disk drive could be inserted and ejected.

### DETAILED DESCRIPTION OF THE INVENTION

This device mainly consists of: a display device, a hard disk drive, a means of converting and supplying power to these components, a means of transferring data between each of these components and the computer, and a docking station capable of accepting and removing the hard disk drive externally. The display device and the hard disk drive share a common power supply.

FIG. 1 shows a functional block diagram of the power subsystem of the present invention. Electrical power may be supplied from a source 100 (e.g. AC 110/220 V, 50/60 Hz) and feeds a power supply 101. The power supply 101 contains a transformer and reduces the source signal's voltage to the appropriate voltage for the display device 102 and the hard disk drive 105 (e.g. to 12 V/5 V DC). The converted signal may be distributed along a power bus to both the display device 102 and the hard disk drive 105, in accordance with industry standards.

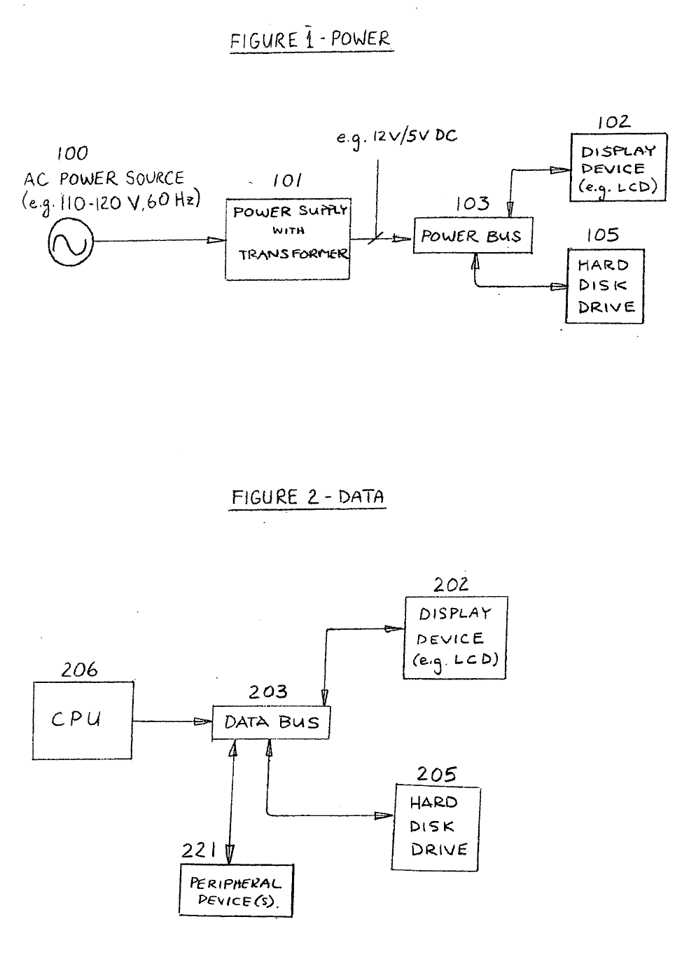

The contents of the hard disk drive can be accessed by peripheral devices connected to the computer, or by the computer itself. FIG. 2 shows a functional block diagram of the data subsystem of the present invention. Data may be communicated from the computer 206 to the display device 202 and the hard disk drive 205, via a data bus 203; using a recognized physical interface standard (e.g. eSATA 3,000, SATA 300, SATA 150, PATA 133, SAS 300, SAS 150, FireWire 3200, FireWire 800, FireWire 400, USB 3.0, USB 2.0, Ultra-320 SCSI, Fibre Channel over optic fiber, Fibre Channel over copper cable, InfiniBand).

In an alternative embodiment, a controller located within the display device enables the display device to communicate directly with the hard disk drive 205. This would allow the display device to play audio or visual media (image or video) while the computer is turned off.

The controller may also permit another device, such as a gaming console or personal video controller, to access the data on the hard disk drive though a wired or wireless interface.

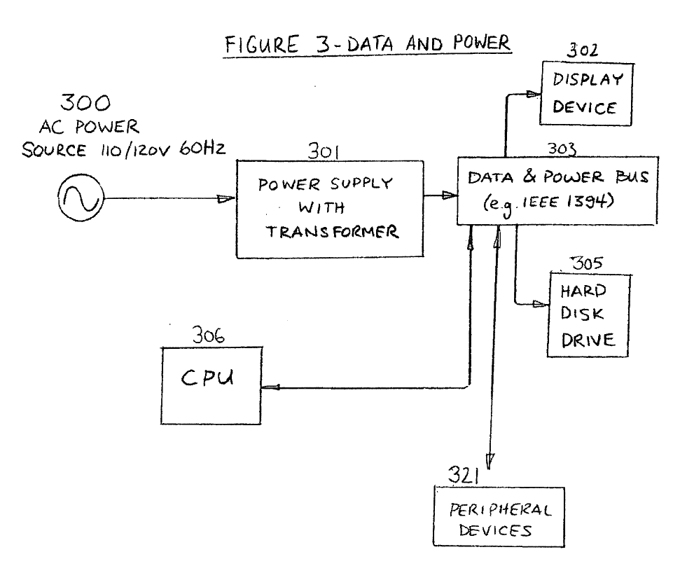

FIG. 3 depicts an alternative embodiment, which depicts a common means for the transmission of power and data. An electrical power source 300 feeds a power supply containing a transformer 301, which reduces the source signal's voltage to the appropriate voltage for the hard disk drive 305 (e.g. 12 V/5 V DC). The reduced signal would be distributed along a common power and data bus 303 to the display device 302 and the hard disk drive 305. The power and data bus would utilize a serial bus interface standard capable of transmitting both data and power in a common cable (e.g. IEEE 1394, USB 2.0 or USB 3.0).

In an alternative embodiment, the video and data cables could be contained within a common insulating sheath; where the cables would split at the ends with separate connectors to connect to the computer.

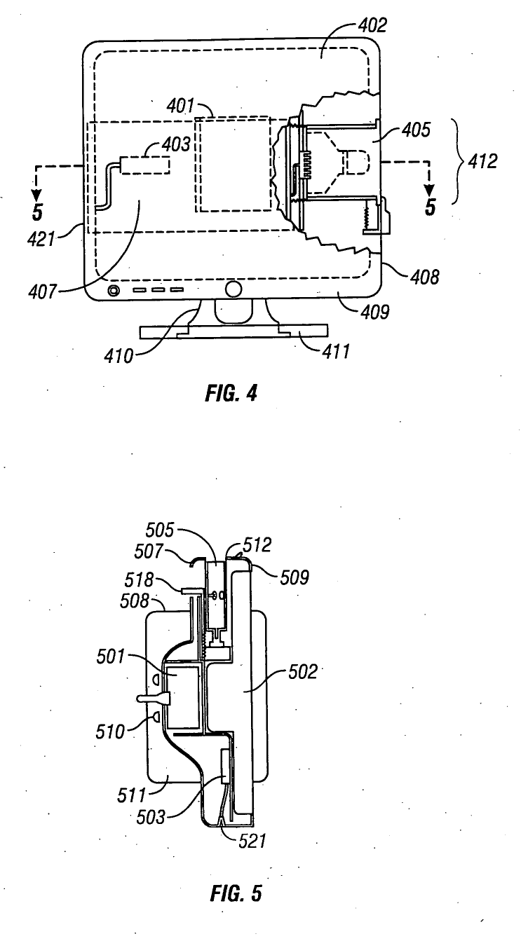

The display device and the hard disk drive are housed within a common enclosure. FIG. 4 shows a front view of this enclosure, consisting of the following components: A power supply 401, a display device 402, a bus 403, and hard disk drive 405. These components are fastened internally to a metal frame 407. The metal frame 407 is fastened to the front bezel cover 408, and then the rear shell 409. Assembly in this order allows the internal components to be serviced without disturbing the display device 402. Finally, the sub-assembly is supported upright from the rear by a support bracket 410, which is attached to a stand 411. The two piece stand and bracket construction allows the user to pan the display device.

FIG. 5 depicts a cross sectional view of the device along section A-A, showing the relative positions of the components and the internal metal frame 507 used to support the components in their assembled position.

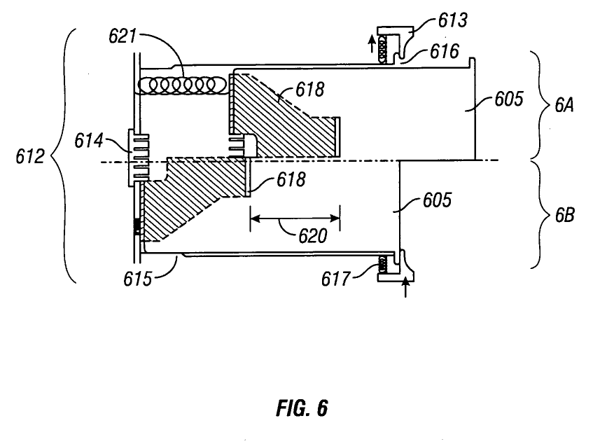

FIG. 6 shows a detailed view of the docking station 612 according to one embodiment of the invention. The figure is divided into two halves. The top half of the figure shows the position of the hard drive after it has been disengaged from the connector, and is ready to be removed from the system (shown as the ‘out position’ 6A). The bottom half of the figure shows the position of the hard drive when it is fully engaged with the connector (shown as the ‘in position’ 6B). The docking station allows the hard disk drive 605 to be conveniently removed or inserted from the side of the display device. Docking from the left-hand side or the right-hand side is preferred, as this permits a handle to be placed at the top of the device. The hard disk drive would be inserted into the docking station by first pushing the retention slide 613 out, and then inserting the hard disk drive all the way inside the receptacle, until the electrical connector 614 engages completely. The side rails of the receptacle 615 would be tapered-in at the closed end of the receptacle 616 to guide the hard disk drive 605 and ensure proper alignment between the mating electrical connectors to prevent damage. When the hard disk drive is inserted completely, the spring 617 acting on the retention slide 613 returns the slide to its original position and retains the hard disk drive 605.

To remove the hard disk drive 605, the retention slide 613 is first pushed out; then the lever 618 on the ejector arm 619 is pulled toward the open end of the receptacle 616. The ejector arm 619 disengages the hard disk drive 605 from the mating connector 614, and pushes it partially out of the receptacle over a stroke distance 620. The ejector arm is then returned by springs 621. The hard disk drive 605 can then be removed from the receptacle 616 by hand.

The invention also encompasses other means of docking the hard disk drive with the display device. Any combination of friction or mechanical locking means may be used to engage or keep engaged the hard disk drive in the docking station. In an embodiment having a docking station opening located at the top of the display device, the hard disk drive may be kept in place by gravity.

The invention may have a means of error-proofing the insertion of the hard disk drive into the receptacle, to ensure correct orientation and alignment of the mating data and power connectors, and thereby avoid damaging the connectors of the docking station and the hard disk drive.

In an alternative embodiment, the position of the docking station would be reconfigurable, so that it could be placed on the opposite side of the unit.

The foregoing description illustrates only certain preferred embodiments of the invention. The invention is not limited to the foregoing examples. That is, persons skilled in the art will appreciate and understand that modifications and variations are, or will be, possible to utilize and carry out the teachings of the invention described herein. Accordingly, all suitable modifications, variations and equivalents may be resorted to, and such modifications, variations and equivalents are intended to fall within the scope of the invention as described and within the scope of the claims.

1. A display device for displaying information and data provided to it by a computer, comprising:
a. a housing, the display device mounted within the housing to display image data to a user;
b. a hard disk drive capable of containing stored data located within the housing;
c. at least one data cable for communicating image data and stored data with the computer;
d. a power supply located in the housing for powering the display device and hard disk drive; and
e. a power cable for receiving electrical power from a power source and delivering it to the power supply.

2. The display device from claim 1, wherein the housing comprises a docking station capable of accommodating the hard disk drive.

3. The apparatus of claim 2 wherein the hard disk drive is removable through the docking station.

4. The apparatus of claim 1 wherein the contents of the hard disk drive may be accessed by a peripheral device connected to the apparatus directly or by the computer itself through the at least one data cable.

5. The apparatus of claim 1 further comprising a controller to allow the display device to communicate directly with the hard disk.

6. The apparatus of claim 2 wherein the docking port for the hard disk drive is located on the top of the unit or the side of the unit.
